(19) United States
(12) Patent Application Publication
(10) Pub. No.: US 2017/0209941 A1
(43) Pub. Date: Jul. 27, 2017

(54) DRILL BIT COLLAR AND METHOD FOR MATERIAL REMOVAL UTILIZING A DRILL BIT COLLAR

(71) Applicant: Modular Designs, Inc., Worcester, MA (US)

(72) Inventors: Charles Chang, Worcester, MA (US); Wayne Partington, Worcester, MA (US)

(21) Appl. No.: 15/418,619

(22) Filed: Jan. 27, 2017

Related U.S. Application Data
(60) Provisional application No. 62/287,558, filed on Jan. 27, 2016.

(51) Int. Cl. B23B 47/28; B23B 35/00

(52) U.S. Cl. CPC B23B 47/287; B23B 35/00; B23B 2215/28; B23B 2231/20; F41A 3/66

(57) ABSTRACT

A drill bit collar for pre-drilling a part to remove material from a part includes an insertion portion configured to be inserted into a hole of a drill guide member; a head portion configured to rest against the drill guide member; and a through hole centered within the insertion portion and extending through the insertion portion and the head portion.

### CROSS REFERENCE TO RELATED APPLICATION

This application claims priority to U.S. Provisional Application No. 62/287,558 which was filed on Jan. 27, 2016, the contents of which are hereby incorporated by reference.

### BACKGROUND

The disclosed embodiments relate to tooling apparatuses and methods for using tooling, and more specifically the disclosed embodiments relate accessories and methods for drilling material from a part, such as a lower receiver for a firearm.

Firearm enthusiasts often prefer to assemble and upgrade their firearms. One example that has become popular are user completed 80% lowers. As is understood, in the art, the AR-15 firearm platform includes a lower receiver unit that may be purchased completed, and ready for assembly, or as an 80% finished lower receiver. An 80% finished lower is a lower receiver unit for an AR-15 platform, or any other platform including but not limited to an AR-10, or 1911 platform, that is not completed and ready for assembly. The difference between a completed lower receiver and an 80% lower is that the 80% lower must have material removed from the lower before the lower is functional.

### SUMMARY

One drawback to 80% lower receivers is that removal of material is difficult. The 80% lower receivers are cast or machined from aluminum or other material and thus can be difficult for a consumer to machine, particularly for consumers that are not equipped with aluminum machining tools. To overcome these drawbacks, a new method and apparatus for machining an 80% lower receiver are provided. The method and apparatus may further be utilized with any other firearm related product or other component part that utilizes drilling to finish the product.

According to one aspect, a drill bit collar for pre-drilling a part to remove material from a part is provided. The drill bit collar may comprise an insertion portion configured to be inserted into a hole of a drill guide member, a head portion configured to rest against the drill guide member, and a through hole centered within the insertion portion and extending through the insertion portion and the head portion.

In some embodiments, the insertion portion is cylindrical. The head portion may also be square shaped. The through hole may be configured to accommodate a drill bit to remove material from the part through the drill bit collar.

According to another aspect, a system is provided for removing material from a part. The system may comprise a jig configured to securely attach to the part. The jig may include a drill guide member. The system may also have a drill bit collar. The drill bit collar has an insertion portion configured to be inserted into a hole of the drill guide member, a head portion configured to rest against the drill guide member, and a through hole centered within the insertion portion and extending through the insertion portion and the head portion.

The system may also include a first drill bit and a second drill bit. The first drill bit has a smaller diameter than the second drill bit. This allows the first drill bit to be configured to fit into the through hole of the drill bit collar to remove material from the part. The second drill bit is configured to fit into the hole of the drill guide member to remove additional material from the part.

As discussed above the part may be an 80% lower receiver of a firearm assembly. The jig may also include a front support and a rear support configured to attach to a front and a rear of the lower receiver. The jig further may have a buffer support that is threaded into the rear of the lower receiver to be flush with or lower than the rear of the lower receiver. The rear support may then be attached to the buffer support. The front support is attached to the front of the lower receiver via a front take-down pin. The jig may also include an upper template. The drill guide member may be secured to the upper template.

According to another embodiment, a method is disclosed for removing material from a part. The method includes assembling a jig and securing the jig to the part. The jig includes a drill guide member. A drill bit collar is inserted into a hole of the drill guide member. The drill bit collar may include an insertion portion configured to be inserted into a hole of the drill guide member, a head portion configured to rest against the drill guide member, and a through hole centered within the insertion portion and extending through the insertion portion and the head portion.

Material is drilled from the part through the drill bit collar and hole of the drill guide member via a first drill bit. The drill bit collar may then be removed from the hole. Material is also drilled from the part through the hole of the drill guide member via a second drill bit. The second drill bit has a larger diameter than the first drill bit.

In some embodiments, the method also includes measuring the drill depth via a drill gauge and clamping a drill stop on the first drill bit and the second drill bit based on the measurement. The jig may also include a template to which the drill guide member is secured. The method may also include routing or milling additional material from the part starting from the hole based on the template.

In some exemplary embodiments, the part is an 80% lower receiver of a firearm assembly. The jig may comprise a front support and a rear support configured to attach to a front and a rear of the lower receiver. The jig may also comprise a buffer support that is threaded into the rear of the lower receiver to be flush with or lower than the rear of the lower receiver. The rear support may be attached to the buffer support. The front support may be attached to the front of the lower receiver via a front take-down pin.

In some embodiments, the jig may comprise side plates connected to the template. The side plates may have a flat bottom such that the jig assembly and the part may rest on a flat surface.

### BRIEF DESCRIPTION OF THE DRAWINGS

FIG. 1 shows an assembled view of a jig for removing material from an unfinished lower receiver, according to one exemplary embodiment.

FIG. 2 shows individual parts of the jig in FIG. 1.

FIG. 3 shows installation of a front support onto a part, according to one exemplary embodiment.

FIG. 4 shows installation of a rear support on a part, according to one exemplary embodiment.

FIG. 6 shows a drill bit collar and associated hardware, according to one exemplary embodiment.

FIG. 7 shows a drill depth gauge with a drill bit and a drill bit collar, according to one exemplary embodiment.

FIG. 8 shows a drill bit collar in use, according to one exemplary embodiment.

FIG. 9 shows a drill bit collar in use, according to one exemplary embodiment.

FIG. 10A shows a part after material is removed with a first drill bit and a drill bit collar, and FIG. 10B shows the part after material is removed with a second drill bit.

FIG. 11 shows a method for removing material from a part with drill bit collar, according to an exemplary embodiment.

The components in the figures are not necessarily to scale, emphasis instead being placed upon illustrating the principles of the invention. In the figures, like reference numerals designate corresponding parts throughout the different views.

### DETAILED DESCRIPTION OF EMBODIMENTS

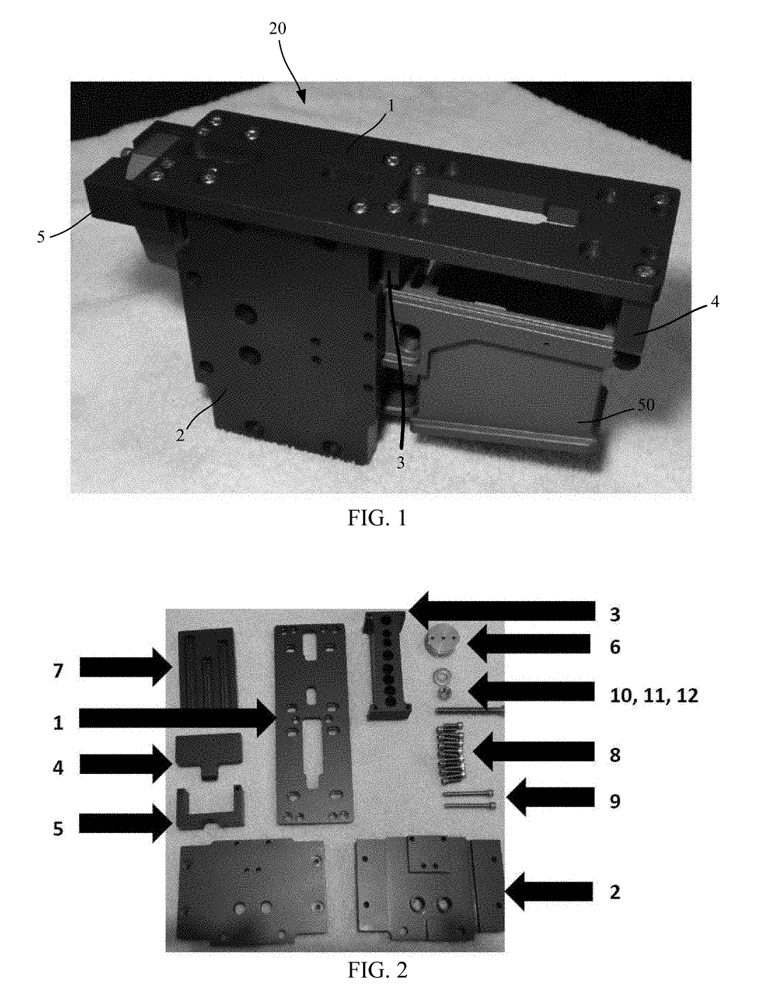

FIG. 1 shows an assembled view of a jig for removing material from an unfinished lower receiver, according to one exemplary embodiment. FIG. 2 shows individual parts of the jig in FIG. 1. As shown in FIG. 1 an example of a jig 20 to guide a user in finishing a part. In this example, the part is an 80% lower receiver 50 for a firearm.

The jig 20 in this embodiment comprises an upper template 1 that is disposed above the part 50 to guide the user in removing material from the part 50 in the appropriate places. The template 1 is connected to side plates 2 that surround the part 50 and extend below the part 50 such that the jig 20 may stably rest on a flat surface and/or be gripped by a clamping device. A drill guide 3 is provided to be below the template 1 aid the user in drilling out material from the part 50. A front support 4, rear support 5, and buffer support 6 connect the jig 20 to the front and the rear of the part 50, as will be discussed in more detail below. Also included are a drill depth gauge 7 and various connector hardware 8-12.

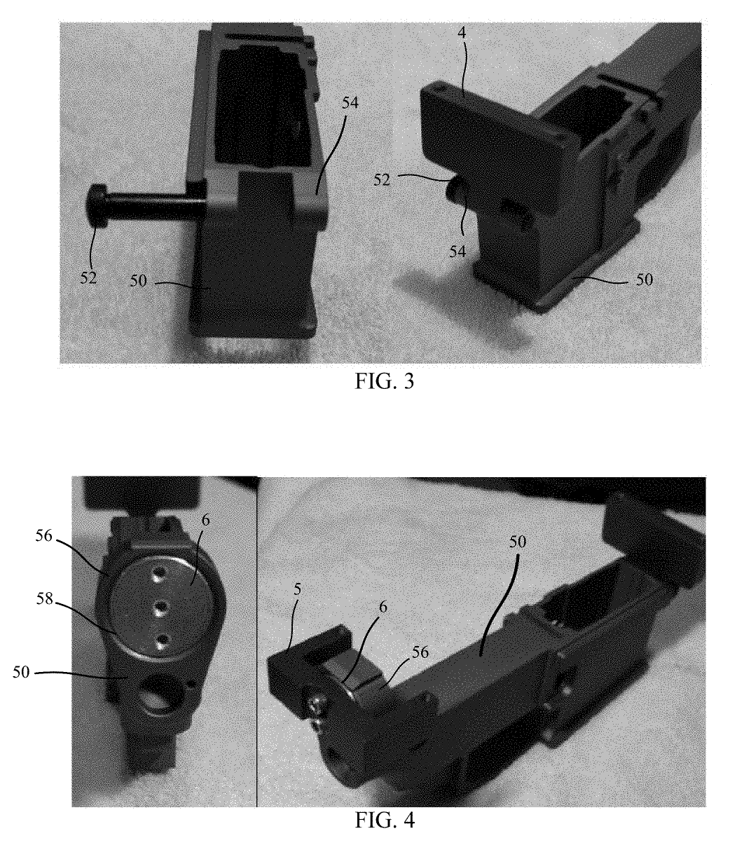

The jig 20 is installed on the part 50 in the following manner. In this embodiment, the part 50 is an AR-15 80% lower receiver. FIG. 3 shows installation of a front support onto a part, according to one exemplary embodiment. A front takedown pin 52 secures the front support 4 to the front of the part 50. The front support includes a flange centered between two projections 54, and the front takedown pin 52 extends through a hole in each of the flange and projections 54 securing the front support 4 to the part 50.

FIG. 4 shows installation of a rear support on a part, according to one exemplary embodiment. The buffer support 6 is configured to thread into an opening 58 of a rear portion 56 of the part 50 the buffer support is threaded into the part 50 until it is flush or below the rear portion 56 of the part 50. Screws 8 are used to connect the rear support 5 to the buffers support 6.

FIG. 5 shows a side view of the assembled jig, according to one exemplary embodiment. After the front support 4 and the rear support 4 are attached to the part 50, the drill guide 3 is aligned to be below the template 1 and is secured to the template 1 via one of the fasteners 8-12. The front support 4 and the rear support 5 are then connected and secured to the upper template 1 and drill guide 3, orienting the template 1 and drill guide 3 correctly with respect to the part 50. The side plates 2 are next fastened to the template 1 to finish the assembly of the jig 20.

As mentioned above, the template 1 guides the user to remove material from the part 50 through drilling. That is, based on the drill guide 3, the user removes material from the part in order to finish the part according to a set of instructions. In one example, the instructions and jig 20 provide for removing material with a ⅜″ drill bit. In an example for finishing a lower receiver for a firearm, a ⅜″ drill bit is used to remove material in the fire-control and rear-shelf pockets before the use of the end-mill or router to finish the feature.

For efficient drilling, a proper feed rate is required to prevent dulling of the drill bit, work hardening, and overheating of the bit. Many enthusiasts who wish to finish such a lower receiver may only have access to more common consumer grade power tools, such as a hand-held drill. However, for large diameter drill bits such as the ⅜″ drill bit, the high downward force and torque required is difficult to achieve with a hand-drill.

Some of the difficulties encountered when using hand-drill with larger drill bits such as the ⅜″ bit include: (1) user fatigue caused by the need to generate the downward pressure over a long time period, (2) excessive time—each hole takes a long time to drill & cordless drill batteries only last for 2 or 3 holes, and (3) excessive heat—drilling inefficiencies cause the lower receiver and the drill to heat up rapidly.

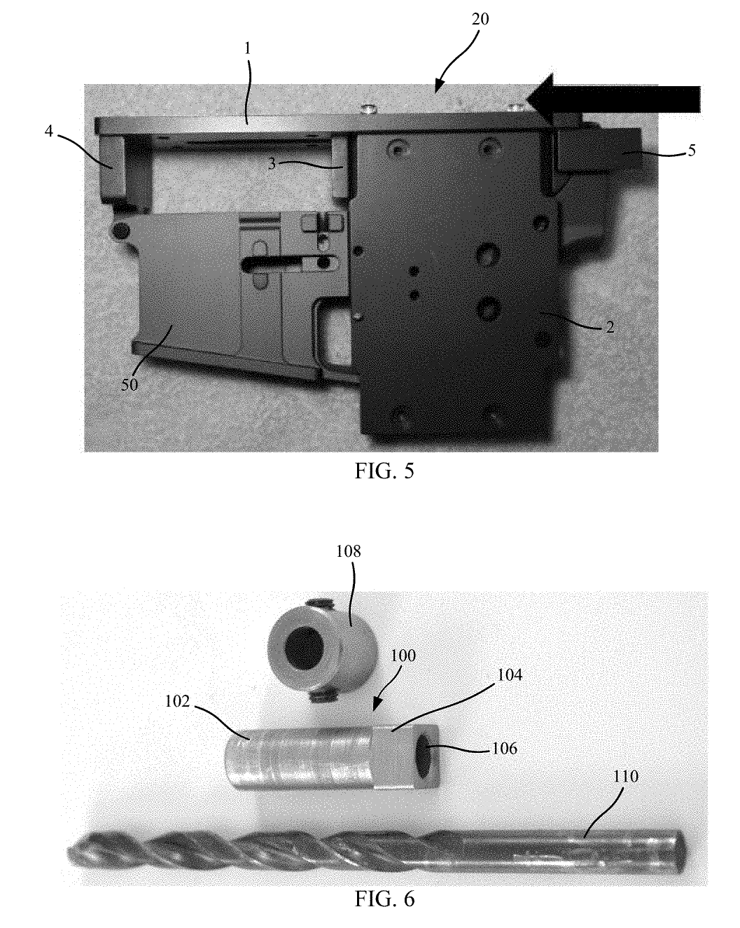

FIG. 6 shows a drill bit collar and associated hardware according to one exemplary embodiment. The drill bit collar according to the disclosed embodiments significantly reduces the effort and time required to drill the holes with a hand-drill, such as corded or battery powered drill. In fact, the lower effort makes it practical to use a cordless drill, which prior to this innovation may not have had sufficient torque, power, battery life or durability to complete the task. The drill bit collar disclosed herein may be compatible with number of jig designs or drill guide systems. Although designed to improve the user experience with a hand-drill, it can also reduce the fabrication time when using a drill press and extend the useful life of drill bits.

In this embodiment, the drill bit collar 100 is provided that reduces the effort typically required in drilling to remove material from a part. For example, pre-drilling a ⅜″ hole with a ¼″ drill-bit utilizing the drill bit collar 100 allows for utilizing a drill bit that has a 2.25× smaller area for reduced effort. The drill bit collar 100 operates to center the ¼″ drill bit in the ⅜″ hole in the jig's drill guide 3. Of course, the disclosed numeric values, such as but not limited to hole diameter and drill bit diameters are exemplary, and the present innovation is not limited to the expressed numeric values.

As shown in FIG. 6, a drill bit collar 100 comprises an insertion portion such as a cylindrical portion 102 and a head portion such as a square head portion 104. A circular through-hole 106 is centered with respect cylindrical portion 102 and extends through the square head 104. The cylindrical portion 102 and the square head 104 are at opposing ends of the drill bit collar 100. The drill bit collar 100 may be formed of any suitable material such as an aluminum or a steel alloy. In some embodiments, the shape of the cylindrical portion 102 and the square head 104 may be other than shown such that the cylindrical portion 102 is shaped maintain itself centered within a drill guide hole 14 and the square head 104 portion maintains the drill bit collar 100 at the top of the drill guide 3.

The drill bit collar 100 is configured to work with a drill bit 110 that fits through the through-hole 106. A drill stop 108 is also provided that can be clamped onto a number of positions along the drill bit 110 to set the depth of a drill of the drill bit 110.

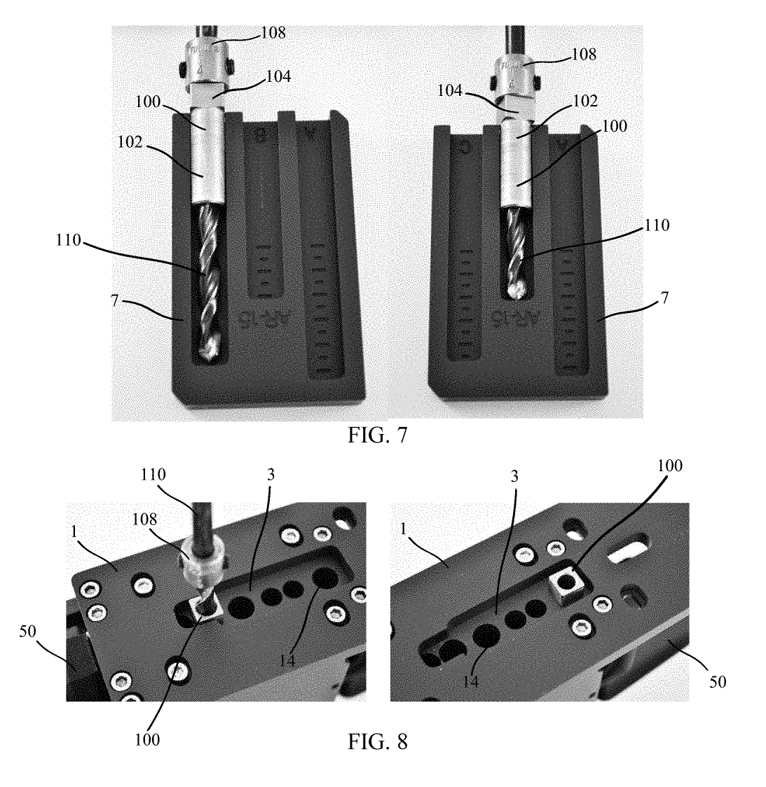

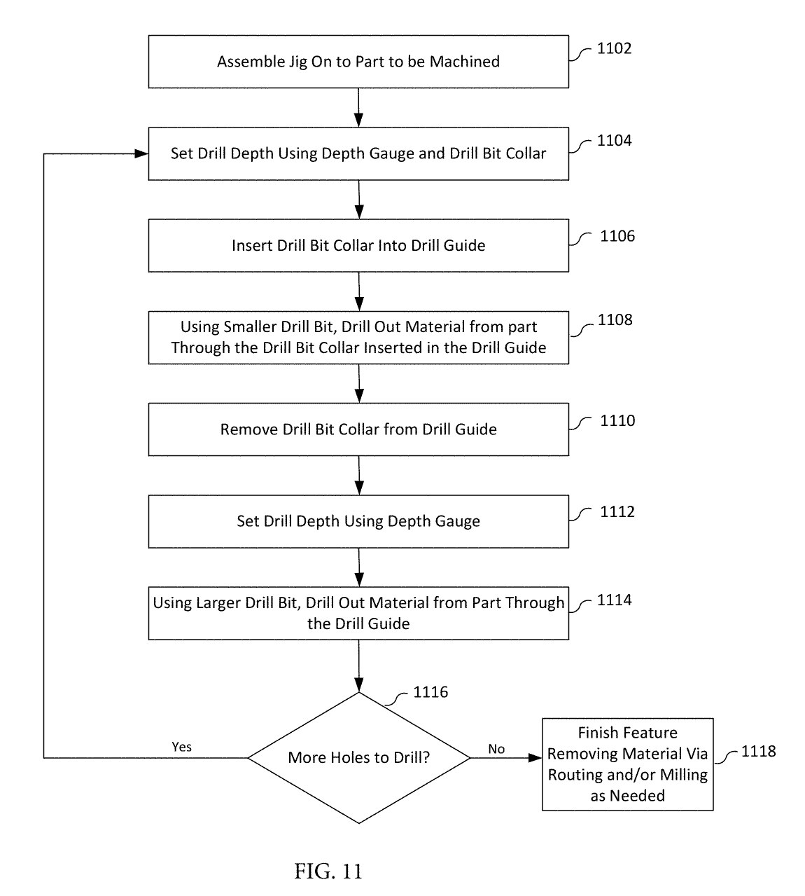

FIGS. 7-10B illustrate the drill bit collar in use, according to an exemplary embodiment. FIG. 11 shows a method for using the drill bit collar to remove material from a part, according to an exemplary embodiment. As shown in FIG. 11, a first step for removing material from a part using the drill bit collar is to assemble a jig onto a part to be machined in step 1102, as discussed above. In step 1104, a drill depth is set using the depth gauge and drill bit collar.

As shown in FIG. 7, the depth gauge 7 allows the user to measure set the drill depth for various lengths as required by the part 50 being finished. In this example, the depth is set using the smaller ¼″ drill-bit. The depth is set with the ¼″ drill bit 110 and the drill bit collar 100 by placing the drill bit 110 and drill bit collar 100 into the depth gauge 7 such that the square head 104 rests on the edge of the depth gauge 7 as shown. The drill stop 108 is then clamped into place to set the depth of the drill according to the depth gauge 7.

It is contemplated that more than once size or diameter of drill bit collar 100 may be used during the completion of a firearm part. That is, there may be multiple drill bit collars 100 having different diameters of a through holes 106 to be used with differing sizes of drill bits 110.

In step 1106, the drill bit collar is inserted into the drill guide to begin drilling.

As shown in FIG. 8, the drill collar 100 is inserted into a hole 14 of the drill guide 3 which is connected to the template 1. That is, the cylindrical portion 102 is inserted into the hole 14. The square head 104 of the drill bit collar 100 sits on top of the drill guide 3 and is supported by the drill guide 3.

In step 1108, the user drills material from the part 50 through the drill bit collar 100 inserted into the drill guide 3, as shown in FIG. 8. With the proper depth set by the drill stop 108, the user drills material from the part 50 by drilling through the drill bit collar 100 until the drill stop 108 meets the square head 104 of the drill bit collar 100.

The drill bit collar 100 may be compatible with any number of jigs for removing material from a part such as jigs for 80% lower receives for firearms. For example,

AR-15 & AR-308 jigs may utilize the drill bit collar 100. Use of the drill bit collar 100 to drill a smaller hole using the drill bit collar 100 before drilling a larger hole may be applied to any firearm assembly or completion process.

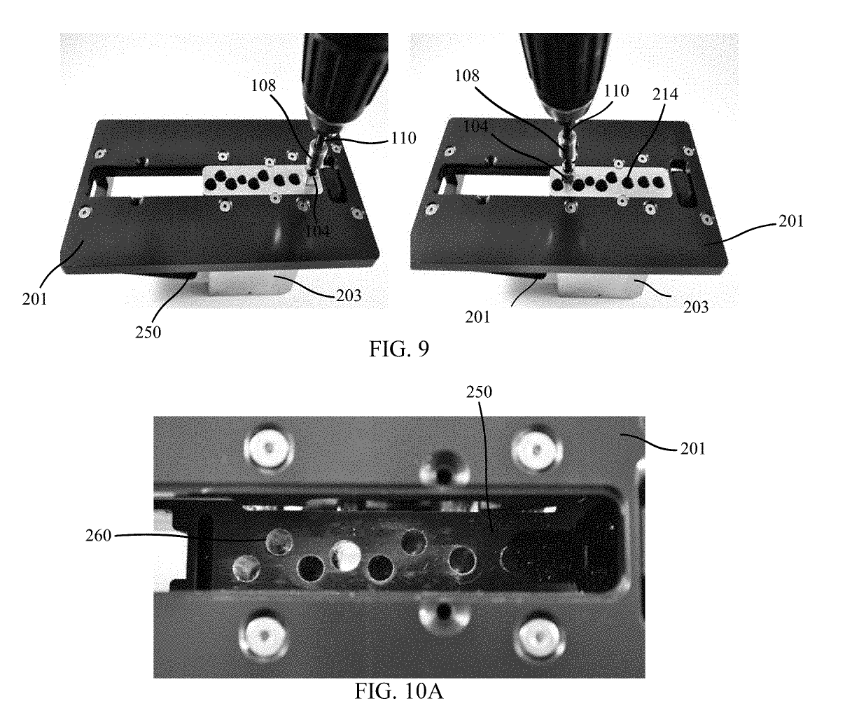

For example, as shown in FIG. 9, the drill bit collar 100 may be used with a second drill bit guide 204 attached to a second template 201 to drill material from a second part 250. Similar as before, the drill bit collar 100 is inserted into the hole 214 of the guide 203, and the drill bit 110 is used to drill material out of the part 250 until the drill stop 108 meets the square head 104.

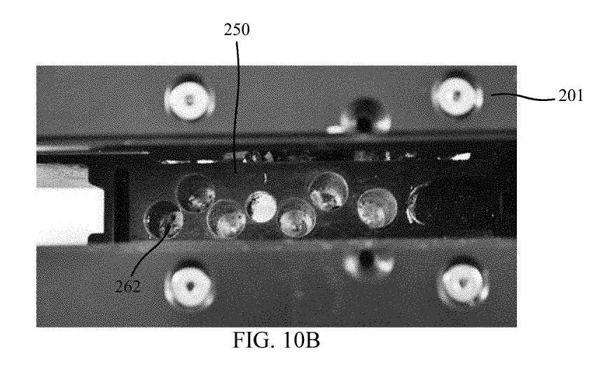

Returning to FIG. 11, in step 1110, the drill bit collar is removed from the drill guide. FIG. 10A shows an example of a part 250 where holes from the first, smaller drill bit have been drilled into the part 250. In step 1112, the user sets the drill depth for a second, larger drill bit. In this example, the user sets the depth for a ⅜″ drill bit. The drill stop similar to drill stop 108 is used to set the depth of the drill using the drill gauge 7.

In step 1114, the larger drill bit is used to drill out material from the part through the drill guide 3. Because the smaller hole was already drilled using the drill bit collar 100 and smaller drill bit 110, the final, larger hole is much easier for the user to drill. Further, the smaller hole helps to keep the larger hole centered as the user drills the hole. FIG. 10B shows an example of the part 250 where holes from the second, larger drill bit have been drilled into the part 250.

In step 1116, the user determines whether there are any more holes to be drilled into the part. If so, the method returns to step 1104 to drill additional holes in the part. If all holes have been drilled, the method proceed to step 1118. In step 1118, final finishing work is done on the feature, such as removing additional material from the part via routing and/or milling processes as needed. Such processes may be completed using the template 1 as a guide with the drill guide 3 removed, for example. The milling and/or routing may be facilitated by the holes drilled during the above described steps. For example, the tool or router may be inserted into one of the holes and remove material beginning from one of the holes.

Modifications to the above-described methods are also envisaged. For example, instead of repeating the entire process for each hole as shown in FIG. 11, steps 1104-1110 may be repeated for each hole needed, and thereafter steps 1112 and 1114 may be completed for each hole.

When drilling the smaller holes, such as the ¼″ holes, the user may frequently bring up the drill bit 100 to clear chips. Although described with example drill bit sizes, any drill bit size may be used with a corresponding interior diameter of the through hole 106 of the drill bit collar 100. The process of predrilling the ¼″ holes using the drill bit collar 100 before drilling larger diameter holes require significantly less effort which speeds up the process and reduces user fatigue. Less wear on the larger drill bit also occurs. The drill bit collar 100 also centers the drill bit 110 in the hole 14, 214 based on the drill guide 3 during initial alignment and during drilling. A hand- drill, for example, provides the rotational force for the drill bit 110.

Other modifications and embodiments may also be considered. For example, instead of a drill collar to be inserted into each hole, the drill collar may be formed to correspond to the drill guide 3 such that the drill collar has multiple cylindrical portions to fit into each hole of drill guide 3. The connection between the various cylindrical portions of such a collar may also allow the drill collar to be built without square heads. As mentioned, multiple collars having progressively larger internal diameters may be used. In further embodiments, instead of a drill gauge, drill bits may be provided with drill stops built in such that the depths of drill are pre-set.

While various embodiments of the invention have been described, it will be apparent to those of ordinary skill in the art that many more embodiments and implementations are possible that are within the scope of this invention. In addition, the various features, elements, and embodiments described herein may be claimed or combined in any combination or arrangement.

What is claimed is:

1. A drill bit collar for pre-drilling a part to remove material from a part, the drill bit collar comprising:
an insertion portion configured to be inserted into a hole of a drill guide member;
a head portion configured to rest against the drill guide member; and
a through hole centered within the insertion portion and extending through the insertion portion and the head portion.

2. The drill bit collar of claim 1, wherein the insertion portion is cylindrical.

3. The drill bit collar of claim 1, wherein the head portion is square shaped.

4. The drill bit collar of claim 1, wherein the through hole is configured to accommodate a drill bit to remove material from the part through the drill bit collar.

5. A system for removing material from a part, the system comprising:
a jig configured to securely attach to the part, the jig comprising a drill guide member;
a drill bit collar comprising:
an insertion portion configured to be inserted into a hole of the drill guide member;
a head portion configured to rest against the drill guide member; and
a through hole centered within the insertion portion and extending through the insertion portion and the head portion;
a first drill bit and a second drill bit, the first drill bit having a smaller diameter than the second drill bit, and the first drill bit being configured to fit into the through hole of the drill bit collar to remove material from the part.

6. The system of claim 5, wherein the second drill bit is configured to fit into the hole of the drill guide member to remove material from the part.

7. The system of claim 5, wherein the part is an 80% lower receiver of a firearm assembly.

8. The system of claim 7, wherein the jig further comprises a front support and a rear support configured to attach to a front and a rear of the lower receiver.

9. The system of claim 8, wherein the jig further comprises a buffer support that is threaded into the rear of the lower receiver to be flush with or lower than the rear of the lower receiver, and wherein the rear support is attached to the buffer support.

10. The system of claim 8, wherein the front support is attached to the front of the lower receiver via a front take-down pin.

11. The system of claim 5, wherein the jig further comprises an upper template, and the drill guide member is secured to the upper template.

12. A method for removing material from a part, the method comprising:
assembling a jig and securing the jig to the part, the jig comprising a drill guide member;
inserting a drill bit collar into a hole of the drill guide member, the drill bit collar comprising:
an insertion portion configured to be inserted into a hole of the drill guide member;
a head portion configured to rest against the drill guide member; and
a through hole centered within the insertion portion and extending through the insertion portion and the head portion;
drilling material from the part through the drill bit collar and hole of the drill guide member via a first drill bit;
removing the drill bit collar from the hole;
drilling material from the part through the hole of the drill guide member via a second drill bit, the second drill bit having a larger diameter than the first drill bit.

13. The method of claim 12, further comprising measuring the drill depth via a drill gauge and clamping a drill stop on the first drill bit and the second drill bit based on the measurement.

14. The method of claim 12, the jig comprising a template to which the drill guide member is secured, the method further comprising routing or milling additional material from the part starting from the hole based on the template.

15. The method of claim 12, wherein the part is an 80% lower receiver of a firearm assembly.

16. The method of claim 15, wherein the jig further comprises a front support and a rear support configured to attach to a front and a rear of the lower receiver.

17. The method of claim 16, wherein the jig further comprises a buffer support that is threaded into the rear of the lower receiver to be flush with or lower than the rear of the lower receiver, and wherein the rear support is attached to the buffer support.

18. The method of claim 16, wherein the front support is attached to the front of the lower receiver via a front take-down pin.

19. The method of claim 12, wherein the jig further comprises a template, and the drill guide member is secured to the template.

20. The method of claim 19, wherein the jig further comprises side plates connected to the template, the side plates having a flat bottom such that the jig assembly and the part may rest on a flat surface.
